(19) United States
(12) Patent Application Publication
(10) Pub. No.: US 2025/0245709 A1
(43) Pub. Date: Jul. 31, 2025

(54) PRINT CONTROL APPARATUS, CONTROL METHOD FOR PRINT CONTROL APPARATUS, AND STORAGE MEDIUM

(71) Applicant: CANON KABUSHIKI KAISHA, Tokyo (JP)

(72) Inventor: SOICHIRO KATAYAMA, Kanagawa (JP)

(21) Appl. No.: 19/030,463

(22) Filed: Jan. 17, 2025

(30) Foreign Application Priority Data
Jan. 29, 2024 (JP) 2024-010975

(51) Int. Cl. G06Q 30/0601; H04N 1/00

(52) U.S. Cl. CPC G06Q 30/0603; H04N 1/00464

(57) ABSTRACT

A print control apparatus includes at least one memory storing a program, and at least one processor that executes the stored program, which cause the at least one processor to acquire contract information that is received from a server system and indicates a contract status regarding a use of a delivery service for delivering a consumable item for a printing apparatus, and perform control, based on the contract information received by the acquisition unit, to display a specific display item for ordering a consumable item while the delivery service is not contracted, and not to display the specific display item while the delivery service is contracted.

### BACKGROUND

### Field

The present disclosure relates to a print control apparatus, a method for controlling the print control apparatus, and a storage medium.

### Description of the Related Art

A service is provided for printing apparatuses having network functions in which consumable items such as ink are managed by a management server and automatically delivered if their remaining amounts become low. In recent years, services that rent device main bodies and consumable items to users who contract with the service at a flat rate with no initial investment or maintenance costs have become widely used with introduction of subscription contracts. In such a contract-based flat rate service, a printing apparatus communicates with a management server, acquires contract information such as a service contract status from the management server, and controls the printing apparatus according to the contract information. According to Japanese Patent Application Laid-Open No. 2021-70161, a system is discussed that displays contract information regarding use of a consumable item delivery service on a printing apparatus and restricts a function of the printing apparatus based on the contract information.

Some printing apparatuses and dedicated applications for the printing apparatuses have a function of displaying information for ordering a consumable item so that a user can easily purchase the consumable item. If the user has a contract for a consumable item delivery service, the user does not need to purchase the consumable item him/herself, but if the information for ordering the consumable item is presented, the user may mistakenly order the consumable item. In Japanese Patent Application Laid-Open No. 2021-70161, it is not discussed that information to be presented to a user is switched based on the contract information.

### SUMMARY

The present disclosure is directed to preventing a consumable item from being mistakenly ordered during a contract for a delivery service that delivers a consumable item for a printing apparatus.

According to an aspect of the present disclosure, a print control apparatus includes at least one memory storing a program, and at least one processor that executes the stored program, which cause the at least one processor to acquire contract information that is received from a server system and indicates a contract status regarding a use of a delivery service for delivering a consumable item for a printing apparatus, and perform control, based on the contract information received by the acquisition unit, to display a specific display item for ordering a consumable item while the delivery service is not contracted, and not to display the specific display item while the delivery service is contracted.

Further features of the present disclosure will become apparent from the following description of exemplary embodiments with reference to the attached drawings.

### BRIEF DESCRIPTION OF THE DRAWINGS

FIG. 1 illustrates an example of an overall configuration of a print system.

FIG. 2 illustrates an example of a hardware configuration of a printer.

FIG. 3 illustrates an example of a hardware configuration of a control apparatus.

FIGS. 4A and 4B illustrate configuration examples of a display unit and an operation unit of the printer.

FIGS. 5A and 5B illustrate control processing according to a first exemplary embodiment.

FIG. 6 illustrates display examples of the display unit of the printer.

FIGS. 7A and 7B illustrate control processing according to a second exemplary embodiment.

FIG. 8 illustrates control processing according to a third exemplary embodiment.

### DESCRIPTION OF THE EMBODIMENTS

Each exemplary embodiment will be described with reference to the attached drawings.

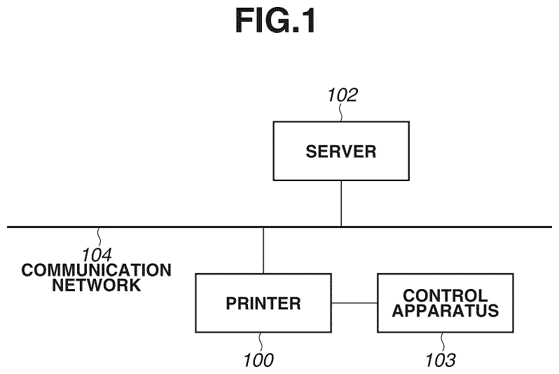

A first exemplary embodiment is described. FIG. 1 illustrates an example of an overall configuration of a print system according to the present exemplary embodiment. The print system is a system in which a printer 100 prints image data received from a server 102 or a control apparatus 103. The print system includes the printer 100, the server 102, and the control apparatus 103. The printer 100 is connected to the server 102 via a communication network 104 such as the Internet and performs bidirectional communication with the server 102. A communication protocol such as Hypertext Transfer Protocol (HTTP) is used for communication between the printer 100 and the server 102.

The printer 100 is connected to the control apparatus 103 via a Universal Serial Bus (USB) cable and transmits and receives data to and from the control apparatus 103. The printer 100 may be connected to the control apparatus 103 via a direct connection with a wireless local area network (LAN) interface to perform bidirectional communication or may be connected to the control apparatus 103 via an infrastructure connection with an external access point to perform bidirectional communication. The printer 100 is an example of a printing apparatus and is assumed to be a commonly used type.

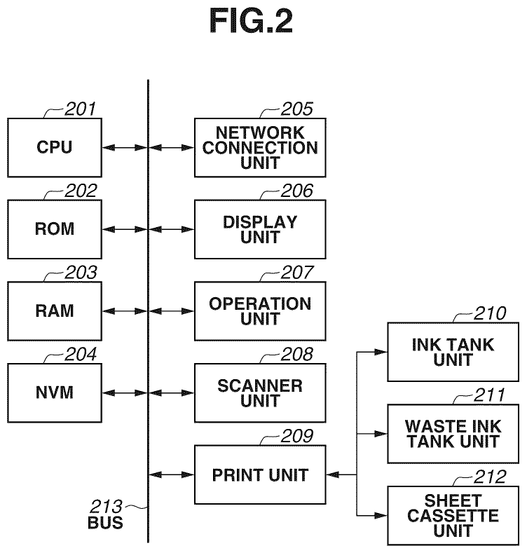

The server 102 is an example of a server system that provides a consumable item delivery service for automatically delivering a consumable item such as ink. The consumable item delivery service will be available if a user enters into an automatic delivery contract or a subscription contract for a consumable item. The consumable item is not particularly limited as long as it is a consumable item that is used in the printer, including ink and a print sheet. The server 102 manages contract information indicating a contract status regarding use of the consumable item delivery service for each printer. The printer 100 stores the contract information received from the server 102 via the communication network 104 in an incorporated non-volatile memory (NVM) 204 of the printer 100, which is described below, and controls display of a display item on a display unit 206 (FIG. 2) of the printer 100 according to the contract information.

The control apparatus 103 is a smartphone, a personal computer (PC), or the like. An application dedicated to the printer 100 and an internet browser are installed in the control apparatus 103 and are used at a time of connecting to or controlling the printer 100. The printer 100 and the control apparatus 103 are directly connected, but the present exemplary embodiment is not limited to this configuration. For example, the printer 100 and the control apparatus 103 may be connected via the communication network 104.

FIG. 2 illustrates an example of a hardware configuration of the printer 100. The printer 100 includes a central processing unit (CPU) 201, a read-only memory (ROM) 202, a random-access memory (RAM) 203, the NVM 204, a network connection unit 205, the display unit 206, an operation unit 207, a scanner unit 208, and a print unit 209. These units are connected to each other via a bus 213 and transmit and receive data therebetween.

The CPU 201 is a central processing unit that controls each unit in the printer 100. The ROM 202 stores various programs and data. The RAM 203 temporarily stores data and the like received by the network connection unit 205. The CPU 201 uses the RAM 203 as a working memory and executes various programs stored in the ROM 202 and the like.

The NVM 204 is a non-volatile memory that stores non-volatile information. The NVM 204 stores individual identification information about the printer 100, shipping destination information, a setting of a language to be displayed on the display unit 206, and the like. According to the present exemplary embodiment, the contract information indicating the contract status regarding the use of the consumable item delivery service received from the server 102 is stored in the NVM 204.

The network connection unit 205 is connected to an external apparatus via the USB cable or the communication network 104 and communicates therewith. According to the present exemplary embodiment, the CPU 201 uses the network connection unit 205 to transmit and receive data to and from the server 102 via the communication network 104. The CPU 201 uses the network connection unit 205 to transmit and receive data to and from the control apparatus 103 via the USB cable.

The display unit 206 includes a liquid crystal display and can display a character, a figure, an indicator, and the like. The CPU 201 controls a display content on the display unit 206.

The operation unit 207 includes a switch and a hard key that enable a user to perform various input operations. A function of the display unit 206 and a function of the operation unit 207 may be integrated such as a touch panel display.

The printer 100 has a copy function, a scanner function, and a print function. The scanner function is realized by the scanner unit 208, and the print function is realized by the print unit 209. The copy function is realized by the CPU 201 transferring image data read and generated by the scanner unit 208 to the print unit 209 and the print unit 209 performing print processing on a recording medium based on the image data.

The scanner unit 208 optically reads a document set on a document platen, converts the read document into electronic data, and further converts the electronic data into a specified file format to generate image data. The CPU 201 transfers the generated image data to the print unit 209, transmits the transferred image data to an external apparatus via the communication network 104, or stores the transferred image data in a storage area of a hard disk, which is not illustrated, or the like.

The print unit 209 prints an image on a recording medium such as a print sheet using an ink-jet method based on image data received from an external apparatus, image data read and generated by the scanner unit 208, and the like. The printing method of the print unit 209 is not limited to the ink-jet method and may be another printing method such as an electrophotographic method.

The print unit 209 includes an ink tank unit 210, a waste ink tank unit 211, and a sheet cassette unit 212. The ink tank unit 210 supplies ink to the print unit 209. The ink tank unit 210 has an ink inlet port and stores ink injected from an ink bottle. As another configuration of the ink tank unit 210, an ink cartridge filled with ink may be mounted on the printer 100, and the ink from the ink cartridge may be supplied to the print unit 209. In a case where the printer 100 is configured with a carriage that scans a recording medium with the print unit 209, the carriage on which the ink cartridge is mounted is an example of the ink tank unit 210. The CPU 201 stores and manages a remaining amount state of ink of each color (black (BK), cyan (C), magenta (M), and yellow (Y)) in the ink tank unit 210 in the NVM 204 or the like.

The waste ink tank unit 211 stores waste ink that is generated when the print unit 209 performs print processing using ink supplied from the ink tank unit 210. The waste ink means ink that is used for other purpose than ejection onto a recording medium, such as ink suction performed before ejecting ink onto the recording medium in order to stabilize the ink ejection. The CPU 201 calculates a remaining capacity that can be stored in the waste ink tank unit 211 from a waste ink amount used by the print unit 209 and a capacity of the waste ink tank unit 211. The waste ink tank unit 211 may be equipped with a sensor that detects the waste ink amount, and the CPU 201 may correct the calculation result of the remaining capacity with a sensor value of the sensor. Alternatively, the CPU 201 may calculate the remaining capacity that can be stored in the waste ink tank unit 211 based only on the sensor value of the sensor.

The sheet cassette unit 212 stores a recording medium such as a print sheet to be supplied to the print unit 209. The print unit 209 forms an image on a sheet supplied from the sheet cassette unit 212.

The CPU 201 calculates sheet information such as the number of remaining sheets in the sheet cassette unit 212 from the number of sheets supplied to the print unit 209 and the number of sheets stored in the sheet cassette unit 212. The sheet cassette unit 212 may be equipped with a sensor that detects the number of sheets stored therein, and the CPU 201 may correct the calculation result of the number of remaining sheets with a sensor value of the sensor. Alternatively, the CPU 201 may calculate the number of remaining sheets in the sheet cassette unit 212 based only on the sensor value of the sensor.

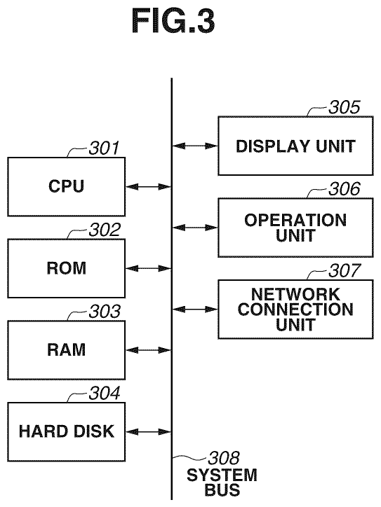

FIG. 3 illustrates an example of a hardware configuration of the control apparatus 103. The control apparatus 103 includes a CPU 301, a ROM 302, a RAM 303, a hard disk 304, a display unit 305, an operation unit 306, and a network connection unit 307. These units are connected to each other via a system bus 308 and transmit and receive data therebetween.

The CPU 301 is a central processing unit that controls each unit in the control apparatus 103. The ROM 302 stores various data. The RAM 303 temporarily stores data and the like received by the network connection unit 307. The CPU 301 uses the RAM 303 as a working memory and executes various programs stored in the hard disk 304 and the like. The hard disk 304 stores an operating system (OS), various applications, various programs, and the like.

The display unit 305 includes a liquid crystal display and displays screens for the application dedicated to the printer 100 and for the internet browser. The CPU 301 controls a display content on the display unit 305. The operation unit 306 includes a keyboard and a mouse that enable a user to perform various input operations. A function of the display unit 305 and a function of the operation unit 306 may be integrated such as a touch panel display. The network connection unit 307 is connected to an external apparatus via the USB cable or the communication network 104 and communicates therewith.

The control apparatus 103 has a function of generating a print job for printing image data using the printer 100 by starting up the application dedicated to the printer 100 and transmitting the print job to the printer 100. The printer 100 that receives the print job from the control apparatus 103 performs print processing on a recording medium based on the image data included in the print job using the print unit 209.

The server 102 can also be realized with the same hardware configuration as illustrated in FIG. 3. The server 102 is not limited to a physical server and may be realized by a virtual server. Each function of the server 102 may be realized by being distributed among a plurality of servers. A storage area such as the hard disk 304 of the server 102 stores device information for each printer and a record table of the contract status for each service. The network connection unit 307 of the server 102 uses a wireless LAN or a wired LAN conforming to standards such as the Institute of Electrical and Electronics Engineers (IEEE) 802.11a and transmits and receives data to and from a device on the same network or the Internet using a Transmission Control Protocol/Internet Protocol (TCP/IP) protocol or the like.

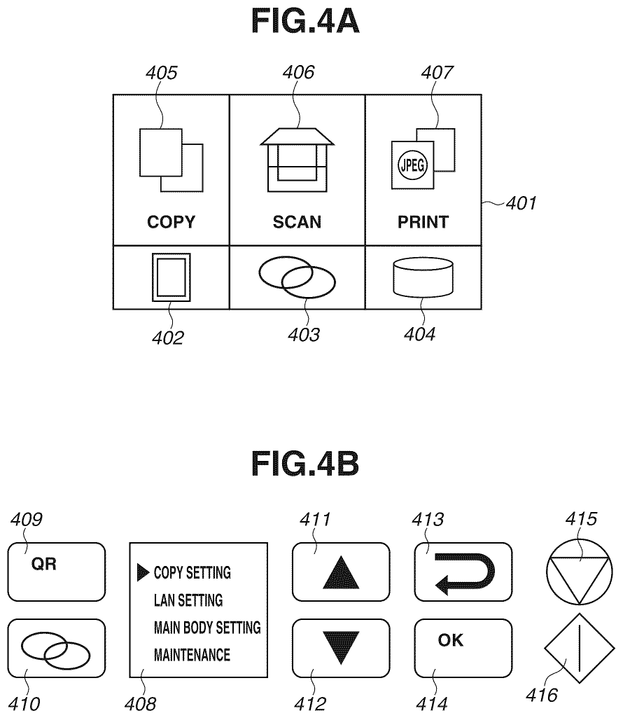

FIGS. 4A and 4B schematically illustrate examples of configurations of the display unit 206 and the operation unit 207 of the printer 100. FIG. 4A illustrates an example in a case where a touch panel display 401 is adopted. The touch panel display 401 displays a user interface (UI) screen under the control of the CPU 201 and receives an operation instruction from a user via the UI screen. In FIG. 4A, a home screen, which is a highest level of menus that the user can operate, is displayed on the touch panel display 401. The home screen is divided into upper and lower sections in which various UIs are provided to receive various instructions from the user. The upper section of the home screen includes a copy area 405 for receiving an instruction to execute copy processing, a scan area 406 for receiving an instruction to execute scan processing, and a print area 407 for receiving an instruction to execute print processing. The lower section of the home screen includes a state display area 402 indicating settings of the infrastructure connection and the direct connection of the printer 100 and a connection state and an area 403 for receiving an instruction to start an operation in a connection setting mode. An area 404 is provided for receiving various setting instructions and an instruction to display the consumable item information.

FIG. 4B illustrates an example in a case where a liquid crystal display (LCD) display 408 and various hard keys 409 to 416 are adopted. When the printer 100 is powered on, the home screen, which is the highest level of menus that the user can operate, is displayed on the LCD display 408. The user can operate a cursor displayed on the LCD display 408 by pressing cursor movement buttons 411 and 412. The user presses an OK button 414 if he/she wants to input an instruction currently selected with the cursor, and presses a return button 413 if he/she wants to return the display on the LCD display 408 to a previous menu screen. By pressing a quick response (QR) button 409, a QR Code® including information necessary for the direct connection to the printer 100 can be displayed.

When the control apparatus 103 reads the QR Code®, the control apparatus 103 and the printer 100 are directly connected and can perform wireless communication therebetween. A stop button 415 receives an instruction to cancel processing being executed while the printer 100 is executing various types of processing. A copy start button 416 receives an instruction to execute copy processing.

Processing is described in which the printer 100 according to the present exemplary embodiment controls display on the display unit 206 of the printer 100 according to the contract information indicating the contract status regarding the use of the consumable item delivery service. According to the present exemplary embodiment, the printer 100 executes processing for controlling the display on the display unit 206 of the printer 100 as a print control apparatus.

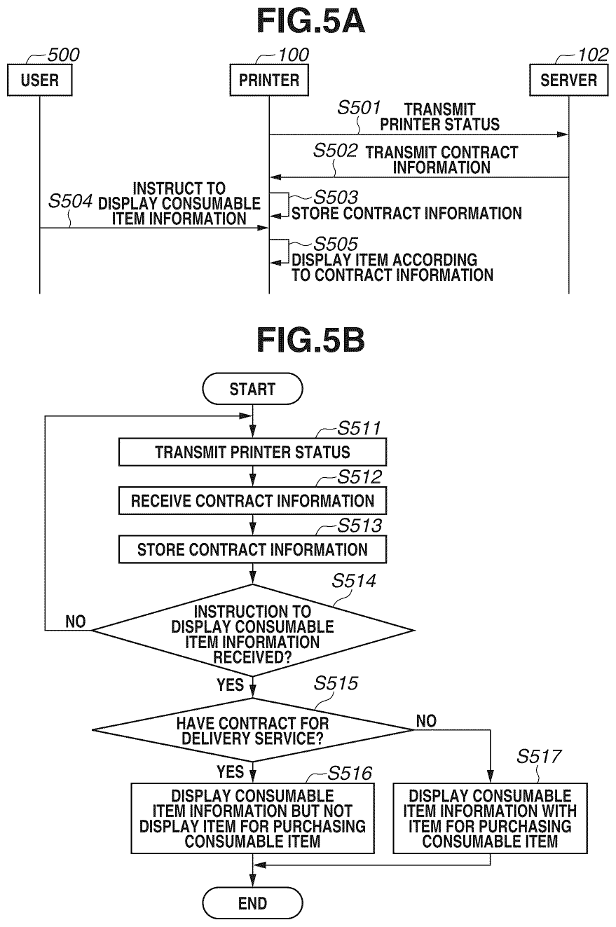

FIG. 5A is a sequence diagram illustrating an operation of the print system according to the present exemplary embodiment. In the following description, each processing (step) is denoted with an S at the beginning.

In step S501, the printer 100 transmits a status of the printer 100 to the server 102. The status transmission is executed in a case where the printer 100 operates and the state of the printer 100 is changed, such as at a time of starting up the printer 100, starting the print processing, ending the print processing, starting the scan processing, ending the scan processing, and occurrence of an error. In a case where the printer 100 has the contract for the consumable item delivery service, the status transmission may include a remaining amount state of the consumable item installed in the printer 100. Accordingly, the server 102 can manage the remaining amount state of the consumable item in the printer 100.

In step S502, the server 102 transmits the contract information about the consumable item delivery service as a response to the status transmission from the printer 100. The contract information about the consumable item delivery service includes information about whether the printer 100 that is a transmission source of the status transmission has the contract for the consumable item delivery service.

In step S503, the printer 100 stores the contract information received from the server 102 in step S502 in the NVM 204.

In step S504, the printer 100 receives an instruction to display ink information about the printer 100 in response to an operation by a user 500 on the operation unit 207.

In step S505, the printer 100 controls the display on the display unit 206 according to the contract information stored in step S503. In a case where an ink delivery service is not contracted, the printer 100 displays remaining ink amount information as well as an item for guiding a user to a homepage for purchasing ink.

On the other hand, in a case where the ink delivery service is contracted, the printer 100 displays the remaining ink amount information but does not display the item for guiding the user to the homepage for purchasing ink.

This completes the processing in the present sequence diagram.

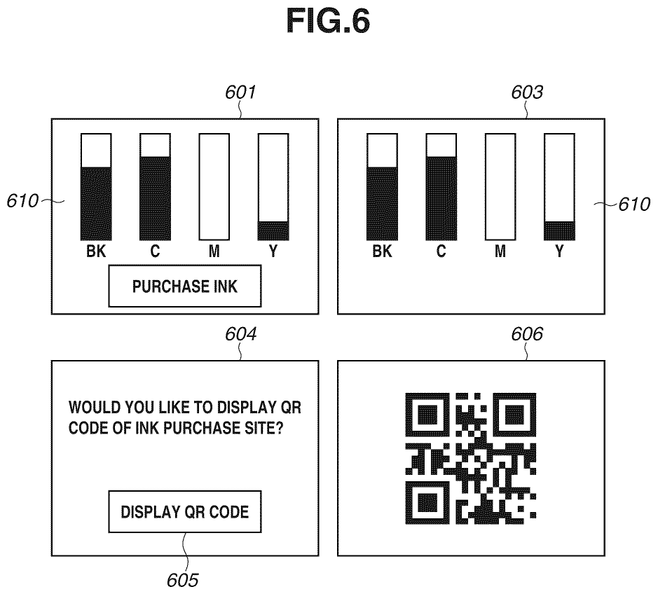

FIG. 6 illustrates display examples of the display unit 206 of the printer 100. According to the present exemplary embodiment, each screen illustrated in FIG. 6 is displayed on the touch panel display 401.

Screens 601 and 603 are examples of screens of the ink information displayed on the display unit 206 of the printer 100. The screen 601 displays remaining ink amount information 610 about each color (BK, C, M, and Y) and an ink purchase guiding button 602 for guiding a user to the homepage for purchasing ink. The remaining ink amount information 610 is an example of consumable item status information. The ink purchase guiding button 602 is an example of a display item for ordering the consumable item. The screen 603 displays the remaining ink amount information 610 but does not display the ink purchase guiding button 602. In step S505, if the ink delivery service is not contracted, the printer 100 displays the ink purchase guiding button 602 on the display unit 206 as illustrated in the screen 601, and if the ink delivery service is contracted, the printer 100 does not display the ink purchase guiding button 602 as illustrated in the screen 603.

In a case where the user presses the ink purchase guiding button 602 on the screen 601, the CPU 201 displays a screen 604 for confirming whether to display the QR Code®. In a case where the user presses a button 605 provided on the screen 604, the CPU 201 displays a screen 606 in which the QR Code® is arranged. A Uniform Resource Locator (URL) embedded in the QR Code® indicates a web page of an online shopping site that sells a consumable item such as ink compatible with the printer 100. A user can access the above-described web page by reading the QR Code® with his/her smartphone or the like and select and order a desired consumable item on the web page. A QR Code® with a different URL embedded can be set for each region where the apparatus is sold. Accordingly, the online shopping site of the distributor for each sales region can be displayed. If a reseller sells the printer 100 and its consumable item, the URL can be changed to the URL of the web page of the reseller.

The processing performed by the printer 100 in the sequence diagram in FIG. 5A is described in detail with reference to FIG. 5B. FIG. 5B is a flowchart illustrating the processing performed by the printer 100. The processing in the present flowchart is realized by the CPU 201 loading a program stored in the ROM 202 into the RAM 203 and executing it.

In step S511, the CPU 201 transmits the status of the printer 100 to the server 102.

In step S512, the CPU 201 receives the contract information about the consumable item delivery service from the server 102.

In step S513, the CPU 201 stores the contract information received from the server 102 in step S512 in the NVM 204.

In step S514, the CPU 201 determines whether the instruction to display the ink information is received from the user 500 via the operation on the operation unit 207. In a case where the instruction to display the ink information is received (YES in step S514), the CPU 201 advances the processing to step S515, whereas in a case where no instruction is received (NO in step S514), the CPU 201 returns the processing to step S511 and waits until an event that triggers the status transmission occurs.

In step S515, the CPU 201 reads the contract information stored in step S513 from the NVM 204 and determines whether the read contract information indicates that the user has the contract for the ink delivery service. If the user has the contract for the ink delivery service (YES in step S515), the CPU 201 advances the processing to step S516, whereas if the user does not have the contract for the ink delivery service (NO in step S515), CPU 201 advances the processing to step S517. According to the present exemplary embodiment, the CPU 201 acquires the contract information received from the server 102 from the NVM 204, but may be configured to access the server 102 and receive the contract information at a timing when the instruction to display the ink information is received from the user 500.

In step S516, the CPU 201 acquires the remaining amount state of ink of each color (BK, C, M, and Y) in the ink tank unit 210 and displays the screen 603 on the display unit 206. In other words, the CPU 201 displays the remaining ink amount information 610 but does not display the ink purchase guiding button 602. Then, the processing in the present flowchart is terminated.

In step S517, the CPU 201 acquires the remaining amount state of ink of each color (BK, C, M, and Y) in the ink tank unit 210 and displays the screen 601 on the display unit 206. In other words, the CPU 201 displays the remaining ink amount information 610 together with the ink purchase guiding button 602. Then, the processing in the present flowchart is terminated.

According to the present exemplary embodiment as described above, display/hiding of a button for ordering a consumable item can be switched on a display of a printer main body according to a contract status regarding a use of a printer consumable item delivery service. Accordingly, it is possible to prevent a consumable item from being mistakenly ordered during the contract for the printer consumable item delivery service.

A second exemplary embodiment is described. According to the first exemplary embodiment, a case is described in which a user directly operates the printer 100 to display the consumable item information on the display unit 206 of the printer 100. According to the present exemplary embodiment, a case is described in which consumable item information about the printer 100 is referred to via an application dedicated to the printer 100 installed in the control apparatus 103 (a computer or a smartphone). The contents described in the first exemplary embodiment are omitted in the following description.

Processing is described in which the control apparatus 103 according to the present exemplary embodiment controls display on the display unit 305 of the control apparatus 103 according to the contract information about the consumable item delivery service of the printer 100. According to the present exemplary embodiment, the control apparatus 103 executes processing for controlling the display on the display unit 305 of the control apparatus 103 as a print control apparatus.

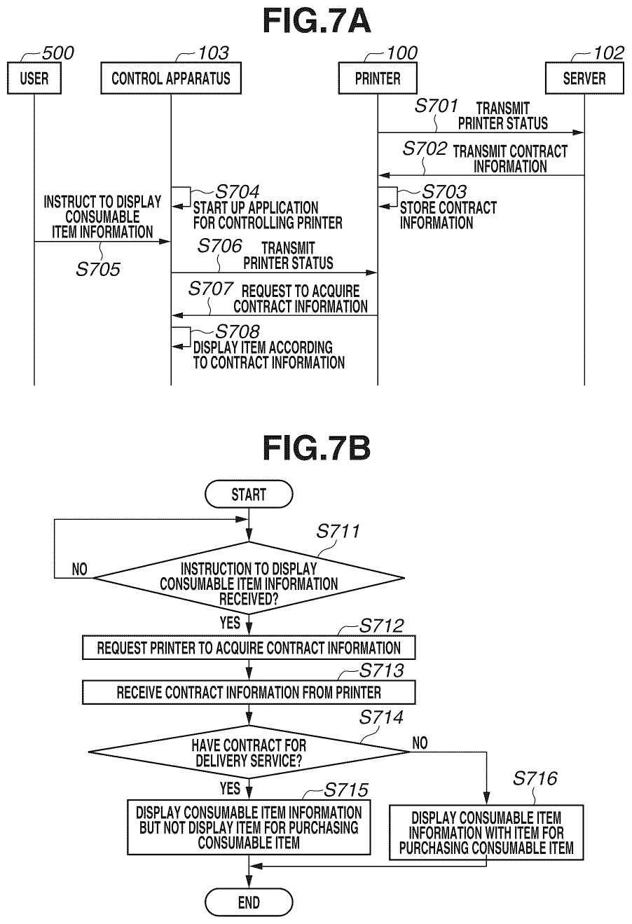

FIG. 7A is a sequence diagram illustrating an operation of the print system according to the present exemplary embodiment. In FIG. 7A, a case is described in which the application dedicated to the printer 100 is installed in the control apparatus 103, and the control apparatus 103 executes processing using the application dedicated to the printer 100.

Processing in steps S701 to S703 is the same as that in steps S501 to S503 in FIG. 5A.

In step S704, the control apparatus 103 starts up the application dedicated to the printer 100 in response to an operation by the user 500 on the operation unit 306 and displays a screen of the application dedicated to the printer 100 on the display unit 305.

In step S705, the control apparatus 103 receives the instruction to display the ink information via the screen of the application dedicated to the printer 100 in response to an operation by the user 500 on the operation unit 306.

In step S706, the control apparatus 103 uses the network connection unit 307 to request the printer 100 to acquire the contract information about the consumable item delivery service.

In step S707, the printer 100 reads the contract information stored in step S703 from the NVM 204 and transmits the read contract information to the control apparatus 103 as a response. The control apparatus 103 acquires the contract information from the printer 100.

In step S708, the control apparatus 103 controls the display on the display unit 305 according to the contract information received in step S707. In a case where the ink delivery service is not contracted, the control apparatus 103 displays remaining ink amount information as well as an item for guiding a user to a homepage for purchasing ink.

On the other hand, in a case where the ink delivery service is contracted, the control apparatus 103 displays the remaining ink amount information but does not display the item for guiding the user to the homepage for purchasing ink.

This completes the processing in the present sequence diagram.

The processing performed by the control apparatus 103 in the sequence diagram in FIG. 7A is described in detail with reference to FIG. 7B. FIG. 7B is a flowchart illustrating the processing performed by the control apparatus 103. The processing in the present flowchart is realized by the CPU 301 loading a program stored in the ROM 302 into the RAM 303 and executing it. The processing in the present flowchart is started in a case where the application dedicated to the printer 100 is started up.

In step S711, the CPU 301 determines whether the instruction to display the ink information about the printer 100 is received via the screen of the application dedicated to the printer 100 by an operation by the user 500 on the operation unit 306. In a case where the instruction to display the ink information is received (YES in step S711), the CPU 301 advances the processing to step S712, whereas In a case where no instruction is received (NO in step S711), the CPU 301 returns the processing to step S711.

In step S712, the CPU 301 uses the network connection unit 307 to transmit a request to acquire the contract information about the consumable item delivery service to the printer 100.

In step S713, the CPU 301 uses the network connection unit 307 to receive the contract information about the consumable item delivery service from the printer 100.

In step S714, the CPU 301 determines whether the contract information received in step S713 indicates that the user has the contract for the ink delivery service. If the user has the contract for the ink delivery service (YES in step S714), the CPU 301 advances the processing to step S715, whereas if the user does not have the contract for the ink delivery service (NO in step S714), the CPU 301 advances the processing to step S716.

In step S715, the CPU 301 acquires the remaining amount state of ink of each color (BK, C, M, and Y) from the printer 100 and displays the screen 603 on the display unit 305. In other words, the CPU 301 displays the remaining ink amount information 610 but does not display the ink purchase guiding button 602.

Then, the processing in the present flowchart is terminated.

In step S716, the CPU 301 acquires the remaining amount state of ink of each color (BK, C, M, and Y) from the printer 100 and displays the screen 601 on the display unit 305. In other words, the CPU 301 displays the remaining ink amount information 610 together with the ink purchase guiding button 602. Then, the processing in the present flowchart is terminated. When the ink purchase guiding button 602 is pressed, a web page of an online shopping site that sells a consumable item may be displayed by the internet browser instead of confirming the display of the QR Code® and the display of the QR Code® as in the screens 604 and 606.

According to the present exemplary embodiment as described above, display/hiding of a button for ordering a consumable item can be switched on an application dedicated to a printer according to a contract status regarding a use of a printer consumable item delivery service. Accordingly, it is possible to prevent a consumable item from being mistakenly ordered during the contract for the printer consumable item delivery service.

A third exemplary embodiment is described. According to the first exemplary embodiment, a case is described in which a user directly operates the printer 100 to display the consumable item information on the display unit 206 of the printer 100. According to the present exemplary embodiment, a case is described in which consumable item information of the printer 100 is referred to via an internet browser of the control apparatus 103. The contents described in the first exemplary embodiment are omitted in the following description.

Processing is described in which the printer 100 according to the present exemplary embodiment controls display on the display unit 305 of the control apparatus 103 according to the contract information about the consumable item delivery service of the printer 100. According to the present exemplary embodiment, the printer 100 executes processing for controlling the display on the display unit 305 of the control apparatus 103 as a print control apparatus.

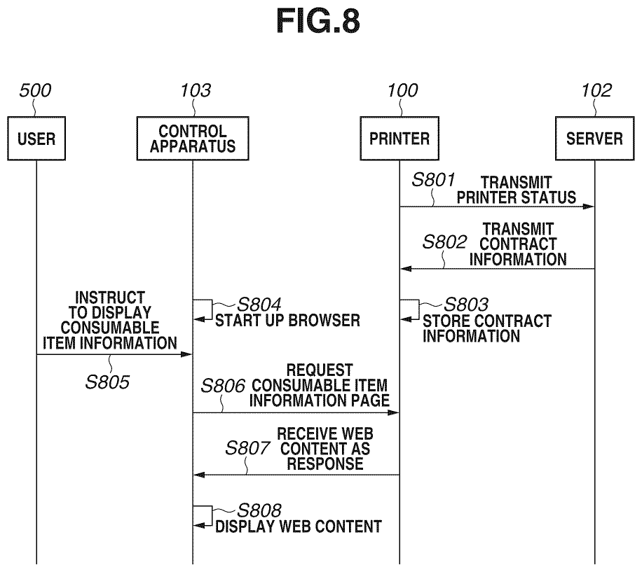

FIG. 8 is a sequence diagram illustrating an operation of the print system according to the present exemplary embodiment. In FIG. 8, the printer 100 operates as an HTTP server, and the control apparatus 103 stores a web application executed by the internet browser. When the printer 100 receives an HTTP request from the control apparatus 103 via the internet browser, the printer 100 transmits Joint Photographic Experts Group (JPEG) data or HyperText Markup Language (HTML) data stored in the ROM 202 or the like as a web content. The control apparatus 103 displays the received web content on a screen of the internet browser.

Processing in steps S801 to S803 is the same as that in steps S501 to S503 in FIG. 5A.

In step S804, the control apparatus 103 starts up the internet browser in response to an operation by the user 500 on the operation unit 306 and displays the screen of the internet browser on the display unit 305.

In step S805, the control apparatus 103 receives the instruction to display the ink information about the printer 100 in response to an operation by the user 500 on the operation unit 306.

In step S806, the control apparatus 103 accesses the printer 100 operating as the HTTP server via the internet browser and requests a web content of an ink information page. The printer 100 that receives the request generates a web content based on the information stored in the ROM 202 and a remaining ink amount state and transmits the web content to the control apparatus 103 as a response. At this time, the printer 100 controls a content of the web content according to the contract information stored in step S803. Specifically, in a case where the ink delivery service is not contracted, the printer 100 includes the remaining ink amount information and a display item for guiding a user to the homepage for purchasing ink in the web content. On the other hand, in a case where the ink delivery service is contracted, the printer 100 includes the remaining ink amount information in the web content but does not include the display item for guiding the user to the homepage for purchasing ink therein.

In step S807, the control apparatus 103 receives the web content from the printer 100.

In step S808, the control apparatus 103 displays the screen of the internet browser in which the web content received in step S807 is arranged on the display unit 305. This completes the processing in the present sequence diagram.

According to the present exemplary embodiment as described above, display/hiding of a button for ordering a consumable item can be switched on a screen of a browser for operating a printer according to a contract status regarding a use of a printer consumable item delivery service. Accordingly, it is possible to prevent a consumable item from being mistakenly ordered during the contract for the printer consumable item delivery service.

According to each of the above-described exemplary embodiments, it is described that the CPU 201 of the printer 100 or the CPU 301 of the control apparatus 103 performs display control processing, but one piece of hardware may perform the above-described various types of control. A plurality of pieces of hardware (e.g., a plurality of processors or circuits) may share processing and control an entire apparatus.

The present disclosure is described in detail based on the various exemplary embodiments, but the present disclosure is not limited to these specific exemplary embodiments and also includes various forms that do not depart from the scope of the present disclosure. Each of the above-described exemplary embodiments is merely one embodiment of the present disclosure and can be combined as appropriate.

According to the present disclosure, it is possible to prevent a consumable item from being mistakenly ordered during a contract for a delivery service that delivers a consumable item for a printing apparatus.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-010975, filed Jan. 29, 2024, which is hereby incorporated by reference herein in its entirety.

What is claimed is:

1. A print control apparatus comprising:
at least one memory storing a program; and
at least one processor that executes the stored program, which cause the at least one processor to:
acquire contract information that is received from a server system and indicates a contract status regarding a use of a delivery service for delivering a consumable item for a printing apparatus; and
perform control, based on the contract information received by the acquisition unit, to display a specific display item for ordering a consumable item while the delivery service is not contracted, and not to display the specific display item while the delivery service is contracted.

2. The print control apparatus according to claim 1,
wherein the stored program further causes the at least one processor to store the contract information received from the server system, and to acquire the contract information from the storage unit.

3. The print control apparatus according to claim 1, wherein the stored program further causes the at least one processor to further function as a print unit configured to execute printing.

4. The print control apparatus according to claim 1, wherein the stored program further causes the at least one processor to acquire the contract information received from the server system from the printing apparatus.

5. The print control apparatus according to claim 1, wherein the stored program further causes the at least one processor to transmit a print job to the printing apparatus.

6. The print control apparatus according to claim 1, wherein, in a case where the specific display item is operated, the stored program further causes the at least one processor to perform processing for displaying a quick response (QR) Code® in which a Uniform Resource Locator (URL) of a web page for ordering a consumable item is embedded.

7. The print control apparatus according to claim 1, wherein, in a case where the specific display item is operated, the stored program further causes the at least one processor to perform processing for displaying a web page for ordering a consumable item.

8. The print control apparatus according to claim 1, wherein, in a case where an instruction to display information about a consumable item is received, the stored program further causes the at least one processor to perform control to display status information about the consumable item together with the specific display item while the delivery service is not contracted, and to display status information about the consumable item but not to display the specific display item while the delivery service is contracted.

9. The print control apparatus according to claim 1, wherein, in a case where a request to display a web page is received from a browser of an external apparatus, the stored program further causes the at least one processor to perform control to display the specific display item on the web page while the delivery service is not contracted, and not to display the specific display item on the web page while the delivery service is contracted.

10. The print control apparatus according to claim 1, wherein the server system is included in a system that provides the delivery service.

11. A method for controlling a print control apparatus, the method comprising:
acquiring contract information that is received from a server system and indicates a contract status regarding a use of a delivery service for delivering a consumable item for a printing apparatus; and
performing control, based on the contract information received by the acquiring, to display a specific display item for ordering a consumable item while the delivery service is not contracted, and not to display the specific display item while the delivery service is contracted.

12. A computer readable non-transitory storage medium storing a program for causing at least one computer to perform a method for controlling a print control apparatus, the method comprising:
acquiring contract information that is received from a server system and indicates a contract status regarding a use of a delivery service for delivering a consumable item for a printing apparatus; and
performing control, based on the contract information received by the acquiring, to display a specific display item for ordering a consumable item while the delivery service is not contracted, and not to display the specific display item while the delivery service is contracted.
